(19) United States
(12) Patent Application Publication
(10) Pub. No.: US 2025/0124338 A1
(43) Pub. Date: Apr. 17, 2025

(54) AUTOMATED HORIZONTAL WELL PLANNING BY REINFORCEMENT LEARNING

(71) Applicant: SAUDI ARABIAN OIL COMPANY, Dhahran (SA)

(72) Inventor: Shahid A Syed, Khobar (SA)

(73) Assignee: SAUDI ARABIAN OIL COMPANY, Dhahran (SA)

(21) Appl. No.: 18/484,800

(22) Filed: Oct. 11, 2023

(51) Int. Cl. G06N 20/00; E21B 41/00

(52) U.S. Cl. CPC G06N 20/00; E21B 41/00; E21B 2200/20

(57) ABSTRACT

A method of using a reinforcement learning algorithm to plan a horizontal well characterized by a starting point (heel (TE)) and an end point (toe (TD)) under a surface location comprises defining an environment for the well that takes into account depth constraints, hazard areas and the existence of pre-existing wells, executing a reinforcement learning algorithm that i) uses initial target TE and TD locations, ii) makes a determination whether a well can be planned in the environment using (TE_{desired}, TD_{desired}) and if it cannot, iii) executes actions to change the target locations to new locations, and determines a state and a reward for the new locations. One of the new locations obtains a higher reward as is-a favored location. It is then determined whether a well can be planned at the favored location based on the environment, and, if so, TE, TD and control points of the favored location are returned.

### FIELD OF THE DISCLOSURE

The present disclosure relates to well planning in the oil and gas industry, and more particularly relates to a method of automated horizontal well planning employing reinforcement learning.

### BACKGROUND OF THE DISCLOSURE

Contemporary machine computing power and machine learning and artificial intelligence methods have been employed to automate numerous tasks in the oil and gas industry. As examples, supervised machine learning algorithms such as neural networks have been used for log-based facies prediction, seismic pattern recognition, prediction and optimization of well performance, etc. In the field of reservoir modelling, genetic algorithms (GA), artificial neural networks (ANN), fuzzy logic (FL) and Bayesian network (BN) algorithms have been applied to model reservoir uncertainty.

Well planning and placement is a key operational activity in the oil and gas industry. Many other investigations and operations have the ultimate objective of defining the optimal sub-surface representation model for use in well planning and placement. Overall, well planning and placement requires a multi-disciplinary team of reservoir engineers, drilling engineers, development geologists, petrophysicists, and well-site and geo-steering geologists to plan and place a well in the desired stratigraphic interval. Significant time is often spent in the planning phase by development geologists upon receiving the engineering parameters of the reservoir. Currently published literature discusses some attempts towards automating this process to save such time and effort. Kristoffersen et al., in the article “An Automatic Well Planner for Efficient Well Placement Optimization Under Geological Uncertainty” (2020), discusses an automated well planning algorithm to efficiently adjust pre-determined well paths to account for near well model properties and increase overall production. Basharat Ali et. al., in “Assisted Field Development Planning Through Well Placement Automation” (2020), applies an automated well planning workflow to plan several wells in the field development planning stage, but does not account for avoiding pre-existing well interference, anti-collision and other geological hazards. Similarly, Karl et al. (“Karl”), in “Automatic Determination of Well Placement Subject to Geostatistical and Economic Constraints” (2002) discloses a simulated annealing algorithm in which random perturbations are applied to a well-path realization and several iterations are executed to converge at a solution. The method disclosed by Karl likewise does not account for pre-existing wells for interference and well-collision hazards.

Kristoffersen et al., cited above, extend the same approach by reducing the well path parameters; however, the pre-determined heel and toe coordinates are still required in this approach. Cullick et al., in U.S. Published Patent Application No. 2010/0179797, entitled “Systems and Methods for Planning Well Locations with Dynamic Production Criteria,” disclose a system that requires defining coordinates for each well target for facilitating the algorithm. Dawar et al. in the publication “Application of Reinforcement Learning for Well Location Optimization” (2021) use reinforcement learning for well location optimization, but the solution described is limited to vertical wells.

Commercially available software packages for well planning typically require a large number of parameters to be provided in order to plan the platform and sites. Accurate estimates of these parameters are not always available or are costly and time-consuming to acquire. Also, in some cases, the algorithm requires predefinition of the starting and end coordinates of the well or the user is heavily involved in facilitating the algorithm.

There is therefore a need for a well planning method that plans and optimally situates horizontal wells that avoid pre-existing wells and other hazards while reducing the number of required input parameters.

### SUMMARY OF THE DISCLOSURE

According to one aspect, the present disclosure describes a method of using a reinforcement learning algorithm to plan a prospective horizontal well that drains a reservoir characterized by a starting point (heel (TE)) and an end point (toe (TD)) under a preset surface location (SL). The method comprises defining a spatial environment in which the horizontal well can be planned that takes into account depth constraints, hazard areas and the existence of pre-existing wells, executing a reinforcement learning algorithm that takes as input initial target TE and TD locations (TE_{desired}, TD_{desired}), makes an initial determination as to whether a well can be planned in the environment using (TE_{desired}, TD_{desired}) and if a well cannot be planned using TE_{desired}, TD_{desired}, executes actions to change from one of the target locations to several new locations (TE₁, TD₁, TE₂, TD₂ . . . . TEₙ, TDₙ), and determines a state and a reward for each of the new locations, wherein one of the several new locations obtains a higher reward from the algorithm and termed a favored location, determining whether a well can be planned at the favored location based on the environment; and returning TE, TD and Control Point(s) of the favored location when it is determined that a well can be planned using TE and TD coordinates of the favored location.

In certain embodiments, the actions are based on two policies, a first policy in which the starting point of the horizontal section of the well (TE) is changed and the horizontal section azimuth of the well is changed, and a second policy in which the starting point of the horizontal section of the well (TE) is changed while the horizontal section azimuth is not changed.

Definition of the spatial environment can include setting three-dimensional upper and lower no-go zone contours which no part of the prospective horizontal well can intersect. Definition of the spatial environment can also include setting a minimum vertical section value of the TE with respect to the surface location (SL) and setting maximum vertical section value of the TE with respect to the surface location (SL).

These and other aspects, features, and advantages can be appreciated from the following description of certain embodiments and the accompanying drawing figures and claims.

### BRIEF DESCRIPTION OF THE DRAWINGS

FIG. 1 is an exemplary illustration of a general schema of a reinforcement learning algorithm.

FIG. 2 is an illustration showing the minimum vertical section (min V.S.), TEᵢₙᵢ, θᵢₙᵢ, TE_{desired}, θ_{desired} and the vertical section after turning the well by an angle α (V.S._{α}) with respect to a surface location (SL).

FIG. 3 is a schematic illustration showing how a collision hazard is modeled and avoided according to an embodiment of the present disclosure.

FIG. 4A is schematic illustration of a drainage area hazard polygon according to an embodiment of the present disclosure.

FIG. 4B is a schematic illustration of a fault hazard according to an embodiment of the present disclosure.

FIG. 5A shows an exemplary radial/star-shaped arrangement of a plurality of horizontal wells.

FIG. 5B shows an exemplary fork-type arrangement of a plurality of horizontal wells.

FIG. 5C shows an exemplary peripheral injection arrangement including three peripheral horizontal wells.

FIG. 6A is a schematic illustration of a scenario in which the deepest depth within the TE circle is greater than the value of the Upper No go Limit_{TE} minus the Offset depth_{TE}.

FIG. 6B is a schematic illustration of a scenario in which shallowest depth within the TE circle is less than the value of the Lower No go Limit_{TE} minus the Offset depth_{TE}.

FIG. 7 is a schematic illustration of an example TE environment which is created by filtering out the hazard areas and depths restrictions coming from Upper No go Limit_{TE}−Offset depth_{TE} and Lower No go Limit_{TE}−Offset depth_{TE} according to an embodiment of the present disclosure.

FIG. 8 is a schematic illustration showing how a 3D Geological model can be sliced at regular intervals from the top to base and corresponding sets of polygons can be created in the process of generating the environment according to embodiments of the present disclosure.

FIG. 9A is a schematic illustration of a polygon generated for a first offset O1 in the process of generating a unified polygon of allowable well zones according to an embodiment of the present disclosure.

FIG. 9B is a schematic illustration of a second polygon generated for a second offset O2 in the process of generating a unified polygon of allowable well zones according to an embodiment of the present disclosure.

FIG. 9C is a schematic illustration of a third polygon generated for a third offset O3 in the process of generating a unified polygon of allowable well zones according to an embodiment of the present disclosure.

FIG. 9D is a schematic illustration of a union of the polygons shown in FIGS. 9A-9C.

FIG. 9E is a schematic illustration of FIG. 9D after a circle of radius equal to the minimum vertical section is subtracted to reach finalized polygon according to an embodiment of the present disclosure.

FIG. 10A is a schematic illustration of a HS fan created according to an embodiment of the present disclosure which includes the set of possible TDs based on TEᵢₙᵢ and αₘₐₓ (the maximum allowed turn)/θ_{desired}.

FIG. 10B is a schematic illustration of the HS Box created according to an embodiment of the present disclosure which is a rectangular envelope based on the maximum V.S. (calculated from SL) on either side of the initial TE_{desired}.

FIG. 11 is a workflow of a method for creating a horizontal section (H.S.) environment according to an embodiment of the present disclosure.

FIG. 12 is a schematic illustration of a selection of TE candidates within the allowed environment according to an embodiment of the present disclosure.

FIG. 13 is a schematic illustration of changes in the vertical section corresponding to a change in TE_{desired} (when |θ_{desired}−θᵢₙᵢ|>αₘₐₓ) according to an embodiment of the present disclosure.

FIG. 14 is a flow chart of an embodiment of a method of planning a star-shaped/fork-type horizontal well platform according to the present disclosure.

FIG. 15 is a schematic illustration of a phase of planning a star-shaped/fork-type horizontal well platform according to an embodiment of the present disclosure.

FIG. 16A depicts two possible peripheral well directions that can be selected based on distinct starting TE locations.

FIG. 16B shows an example of a TE environment for a peripheral gas injection well.

FIG. 17 is a flow chart of an embodiment of a method for peripheral injection platform planning according to the present disclosure.

FIG. 18 is a pictorial illustration of the peripheral injection platform planning process described above with respect to FIG. 17.

FIG. 19 is a schematic flow diagram of a dual policy reinforcement learning schema according to the present disclosure.

FIG. 20A is a schematic illustration of a number of states (each labeled S1) evaluated under a first policy in a reinforcement learning algorithm according to an embodiment of the present disclosure.

FIG. 20B is a schematic illustration of a number of states (each labeled S2) evaluated under a second policy in a reinforcement learning algorithm according to an embodiment of the present disclosure.

FIG. 21 is a flow chart of a comprehensive method for horizontal well design according to an embodiment of the present disclosure.

### DETAILED DESCRIPTION OF CERTAIN EMBODIMENTS OF THE DISCLOSURE

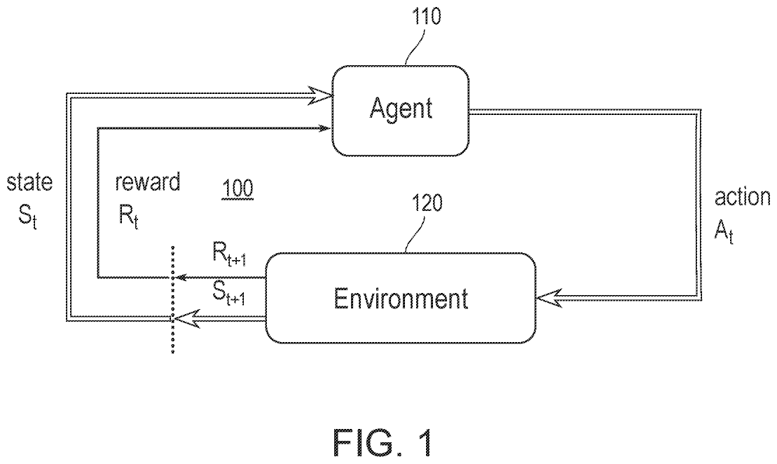

Reinforcement learning is a branch of machine learning in which the presence of labelled or unlabeled data is not mandatory for training the algorithm. An exemplary illustration of a general schema of a reinforcement learning algorithm is shown in FIG. 1. The two entities of the schema are an agent 110 and an environment 120. The agent 110 interacts with the environment 120 through an action (Aₜ) selected from a set of available actions (Aₜ . . . Aₙ) based on a configured policy. In turn, the environment 120, in response to the action (Aₜ), returns a state (Sₜ) and a reward (Rₜ). The reward (Rₜ) (with a higher reward indicating a positive outcome and a smaller reward indicating a comparatively less positive outcome) is used as a guide to influence the agent toward a set of actions that bring about an optimal state (S_{X}). Through this interaction, which occurs iteratively, the algorithm “learns” from the environment via the states and rewards. It will be appreciated that the agent, environment, actions, states and rewards are configured via one or more software modules executed on one or more hardware processors, acting serially or in parallel.

A reinforcement learning algorithm illustrated generally in FIG. 1 can be adapted to automate the process of planning multiple horizontal wells from either an offshore platform or an onshore pad. A planned horizontal well is designed to target a single reservoir unit consisting of one layer or sublayer of a given reservoir. In this implementation, a horizontal well starts exposing the reservoir at a “heel” location (referred to as “TE”) and ends at a “toe” location (referred to as “TD”). The reinforcement learning algorithm is designed to determine the optimal TE and TD locations for a horizontal well.

One of the parameters that is set at the outset is the surface location (SL) from which the origin of the well starts. Once the surface location is confirmed, an initial process of planning a well to target a reservoir involves determining an area in which the wells can be planned without violating certain parameters. The constraining parameters include: depth constraints referred to as upper no-go limits (UNGL) and lower no-go limits (LNGL); reservoir structure, including “sweet spots” and geological hazards such as faults; and pre-existing well's geometry that requires spacing as determined by well spacing requirements and the need to avoid collision hazard. Other initial parameters include a minimum and maximum vertical section, a minimum and maximum horizontal length, and a minimum well spacing.

By way of brief explanation, the upper no-go limits and lower no-go limits are fixed depths or surfaces which define boundaries for the search for the TE and TD locations. The UNGL and LNGL are determined based on the estimated distance from gas/oil contact and oil/water contact, respectively, taking into account the longevity of the well and efficiency of injection. For fixed depth limits, the UNGL and LNGL can be contour lines adjusted for an offset depth required to plan the Target coordinates TE and TD below the top of the reservoir. For surface limits, the boundaries are an intersection of the reservoir structure map and the surface. A geological model provides the reservoir structure, and locations of sweet spots and other geological hazards such as faults. The pre-existing wells in the field have two effects on the planning of the well. First, pre-existing wells constitute potential collision hazards with the new well being planned. Typical well location and well-path surveys have inherent measurement errors that are defined as an ellipse of uncertainty. With increased depth, the ellipses become larger in size due to greater measurement uncertainties. The ellipses are evaluated in three dimensions. A prospective horizontal well cannot pass through any of ellipses of uncertainty of any of the pre-existing wells in the field. Additionally, each pre-existing well producing from the same reservoir typically has an associated drainage area. It is economically wasteful to have more than one well producing from the same area of a reservoir. Therefore, this is another factor that is taken into account for well spacing. In short, the geometry of the pre-existing wells is considered as part of the environment in configuring the reinforcement learning algorithm.

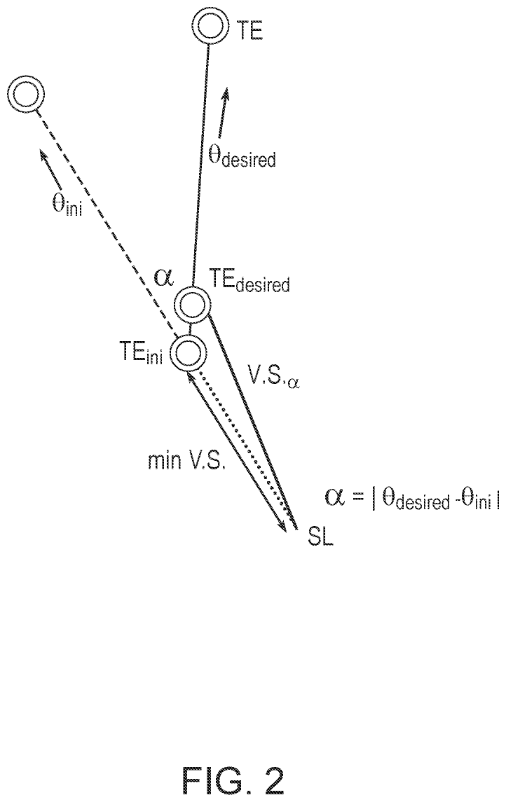

The vertical section (V.S.) for any point of the well is the distance between the surface location of the well and that point projected onto a reference vertical plane. When the heel point (TE) is selected, this plane passes between the SL and the heel point. The vertical section can be used as a proxy for drilling parameters of dog leg severity (DLS) and the maximum length of the section. The minimum vertical section is the distance required to land a well in the reservoir using the maximum DLS without turning. If there is any turning required such that the azimuth from SL−TEᵢₙᵢ and the azimuth from TE_{desired}−TD differ by the angle α, then the vertical section for the TE is termed as vertical section (α). TEᵢₙᵢ is the TE achieved if well does not incorporate any turn from SL−TD and the Surface projection of the well trajectory is a straight line from SL−TD. TE_{desired} is the TE after adjusting for the turn. FIG. 2 illustrates the minimum vertical section to TEᵢₙᵢ and vertical section (α) to TE_{desired} with respect to a surface location (SL). A maximum vertical section implies that, based on the drilling best practices, the well cannot be drilled further than this point because longer sections can pose substantial safety risks. The maximum vertical section thus defines the maximum reach of the heel point (TE).

The minimum and maximum horizontal section length (H.S.L.) are the minimum and maximum values for the horizontal section length (H.S.L.) for an acceptable well. These parameters are determined by a reservoir engineer in order to optimize the lateral length for achieving a required production rate. Generally, the maximum value is the most desirable but, if the reservoir area is crowded with wells, other values down to the minimum horizontal length can be used. Similarly, the minimum well spacing is the minimum well distance required between the wells that are producing from the same reservoir to avoid well Interference.

### Environment Design

The parameters described above define the environment in which a targeted well is to be planned. For any well the parameters can be same or different for the TE and TD. Therefore, the reinforcement learning algorithm is designed with the consideration that the TE and horizontal section (HS) environments may be dealt with differently based upon their input parameters. The pre-existing wells and geological hazards such as faults and non-reservoir zones are first defined to design the environment. The pre-existing wells, UNGL, LNGL and hazards form no-go zones that the algorithm is configured to avoid (i.e., TE and HS are not selected in the no-go zones).

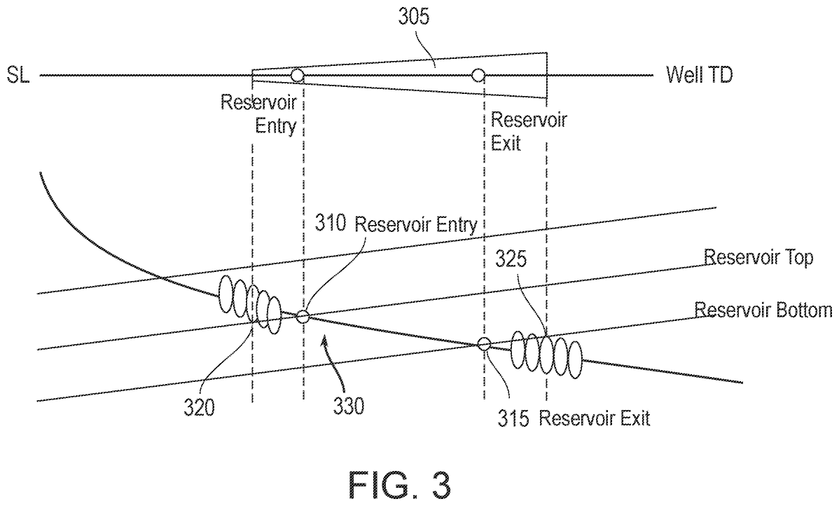

FIG. 3 is a schematic illustration showing how a collision hazard is modeled according to an embodiment of the present disclosure. At the top of the figure a horizontal line indicates the map view for the well and a collision hazard polygon 305 is shown. The polygon includes and subsumes a surface projection of the reservoir entry point 310 and reservoir exit point 315. The starting location of a collision hazard is defined by the point on the well where the ellipse of vertical uncertainty just touches the reservoir top, which is point 320 in FIG. 3. Similarly, the end location of the collision hazard is defined by the point on the well where the ellipse of vertical uncertainty just touches the reservoir bottom, point 325. It is not safe to pass a well in the region 330 which lies inside the uncertainty zones.

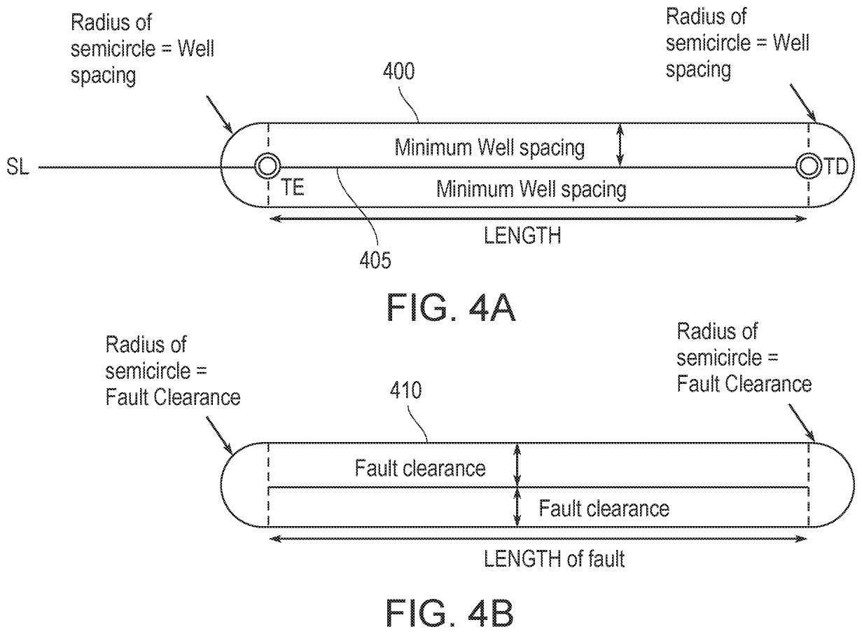

A drainage area hazard can be represented as an envelope around the wellbore with semicircular regions on each end. A schematic illustration of a drainage area hazard polygon 400 is shown in FIG. 4A. The well trajectory 405 is in middle of the envelope, and the breadth of the envelope is set at twice the well spacing parameter. The length of the drainage area zone 400 is equal to the length between the TE and TD.

A schematic illustration of a fault hazard is shown in FIG. 4B. Faults are linear features, and in some instances, faults can pose a risk to drilling. The decision to cross or avoid a fault is based upon the geological characteristics of the fault. The planning process can seek to avoid drilling through faults and keep some clearance from the fault. Faults can be treated similarly to drainage hazards by setting a fault hazard polygon envelope 410 around the fault with semicircular regions at each end. The width of the envelope is set at twice the fault clearance. The length of the fault hazard polygon is equal to the length of the fault.

Other geological hazards can also be used to design the environment for the well planning leaning algorithm. Such hazards, referred to as geo-bodies, can be derived from three-dimensional modeling or seismic attributes. The geometric features of the geo-bodies are predefined from the data available.

To recognize all the hazards that should be avoided to plan the wells, potential areas in which wells can be planned are initially outlined. At this initial stage, depth no-go zones are not yet considered and the potential areas are based solely on the parameters of maximum vertical section for TE and the maximum horizontal section length to achieve a maximum well reach. For a given surface location (SL), the area of Interest (AOI) for a set of TE/TD coordinates is a circle with a radius equal to maximum vertical section (VS) plus maximum horizontal section length (HSL) plus (W) the well spacing for the drainage area or the maximum well spacing to avoid collisions with pre-existing wells. The greater of the well spacing for the drainage area or the maximum well spacing to avoid collisions with pre-existing wells will be chosen for the value of W.

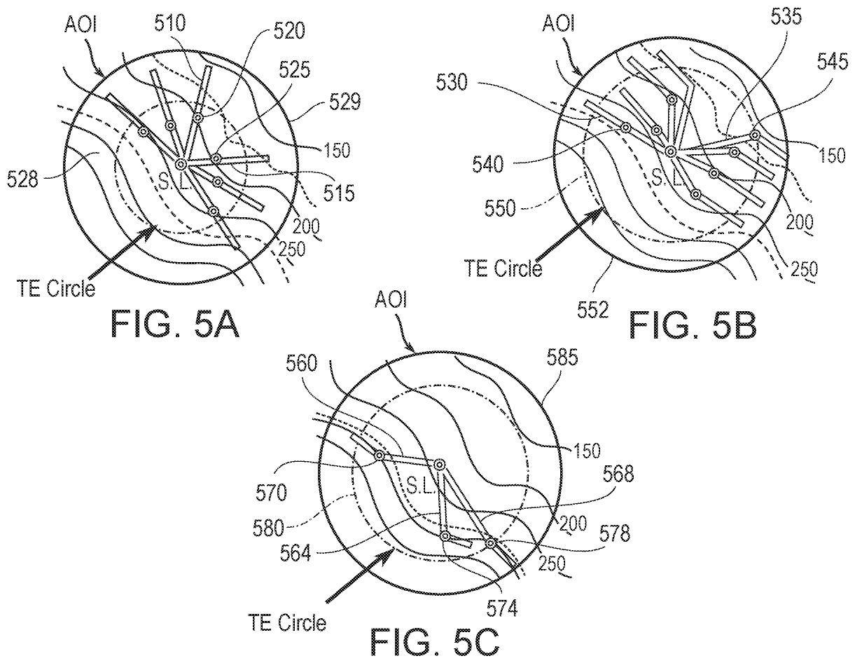

FIGS. 5A-5C illustrate three of the more common horizontal well arrangements from a single platform/pad in an area of interest (AOI). FIG. 5A shows a radial arrangement of a plurality of horizontal wells, e.g., 510, 515. The TE locations 520, 525 of the respective wells e.g., 510, 515 are located within a TE circle 528 and the horizontal section of the wells may extend from the heel (TE) in nearly the same direction as the direction from SL-heel (TE). The horizontal wells 510, 515 do not extend beyond the area of interest boundary 529. FIG. 5B shows a fork-type arrangement of a plurality of wells e.g., 530, 535. The TE locations 540, 545 of the respective wells e.g., 530, 535 are also located within a TE circle 550. However, in the case of a fork-type arrangement, the horizontal section of the wells generally (except some) extend in a different direction from the TE than the direction from SL-heel (TE), on either side of the surface location. The horizontal wells e.g., 530, 535 similarly do not extend beyond the area of interest (AOI) boundary 552. FIG. 5C shows a peripheral injection arrangement including three peripheral horizontal wells 560, 564, 568. The TE locations 570, 574, 578 of the respective wells 560, 564, 568 are located within a TE circle 580. In peripheral injection wells the horizontal wells 560, 564, 568 may extend in different directions from the TE than the direction from SL-heel (TE), generally following a geological periphery. The horizontal wells 560, 564, 568 similarly do not extend beyond the area of interest (AOI) 585.

The TE environment is set as a circle of maximum V.S. and removing the areas shallower than the UNGL and deeper than the LNGL and the hazards. In cases in which there is a pre-defined offset from the top of the reservoir to plan the TE, this is accounted for by subtracting the offset value from the absolute value of the UNGL and LNGL. The absolute values are important because generally the depths are considered in TVDss (true vertical depth subtracting sea level at well point) which by convention are all negative numbers below sea level. Following this subtraction, the convention of negative numbers for TVDss is followed again.

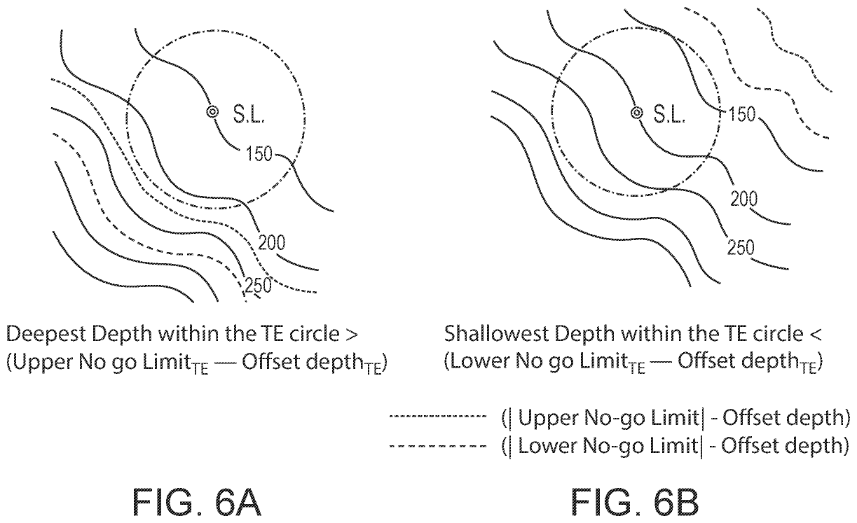

There can be different scenarios based on the Upper and Lower NGL; however, there are two scenarios in which it is not possible to choose the TE and subsequently plan the wells. These scenarios occur when the deepest depth within the TE circle>(Upper No go Limit_{TE}−Offset depth_{TE}) (illustrated in FIG. 6A) or the shallowest depth within the TE circle is <(Lower No go Limit_{TE}−Offset depth_{TE}) (illustrated in FIG. 6B) In such cases the vertical section range, the No go limits or Offset depth_{TE} is not suitable to plan the wells. In the cases in which a range of offset depths is presented, the depth ranges within the TE circle are evaluated for a range of offset depths to make a determination.

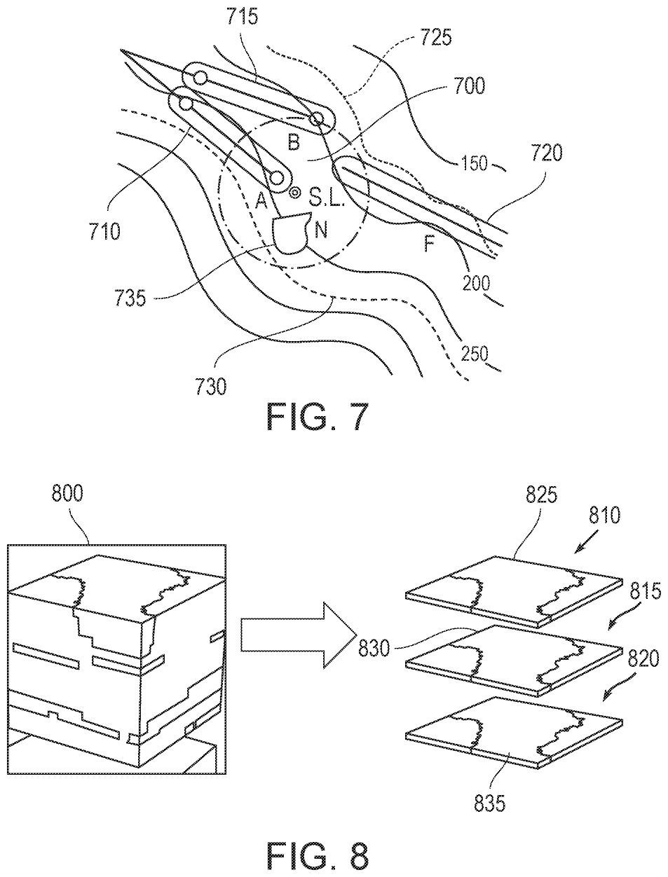

After these parameters have been confirmed as suitable to plan the wells, the environment is generated. FIG. 7 schematically illustrates an example environment 700 which is created by filtering out the hazard areas 710, 715, 720 and depths restrictions coming from Upper No go Limit_{TE}−Offset depth_{TE} 725 and Lower No go Limit_{TE}−Offset depth_{TE} 730. A non-reservoir hazard 735 is also included, which is derived from a 3D Geological model of the reservoir. The environment 700 in the example shown in FIG. 7 is associated with a single offset depth. In cases in which there is no offset depth, the reservoir can be evaluated from the top to the bottom to generate the environment. Such evaluation can proceed by determining all possible polygons from the top to the bottom of the reservoir sequentially and then using a union of all these polygons to design the environment for the candidate TE. FIG. 8 is a schematic illustration showing how a 3D model 800 can be sliced at regular intervals e.g., 810, 815, 820 from the top to base and corresponding sets of polygons 825, 830, 835 can be created. While three slices are shown, this is merely for illustrative purposes, and any number of slices can be used.

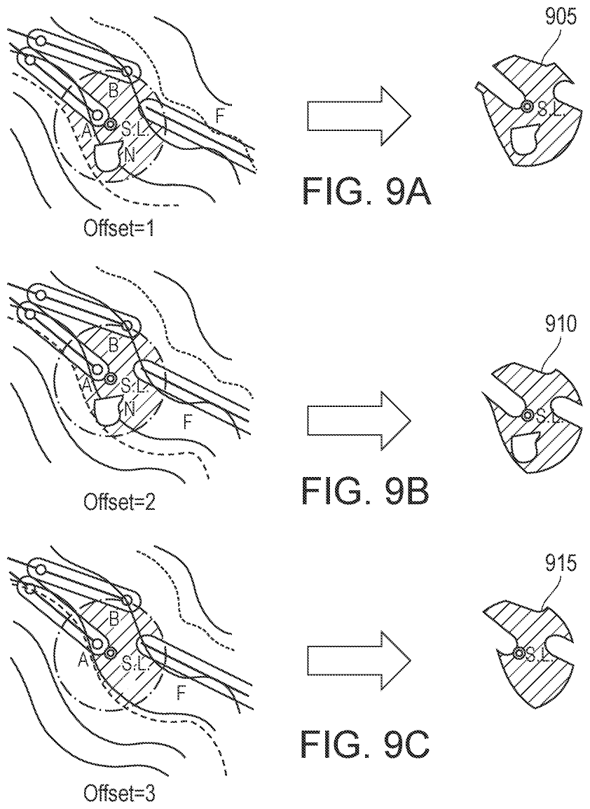

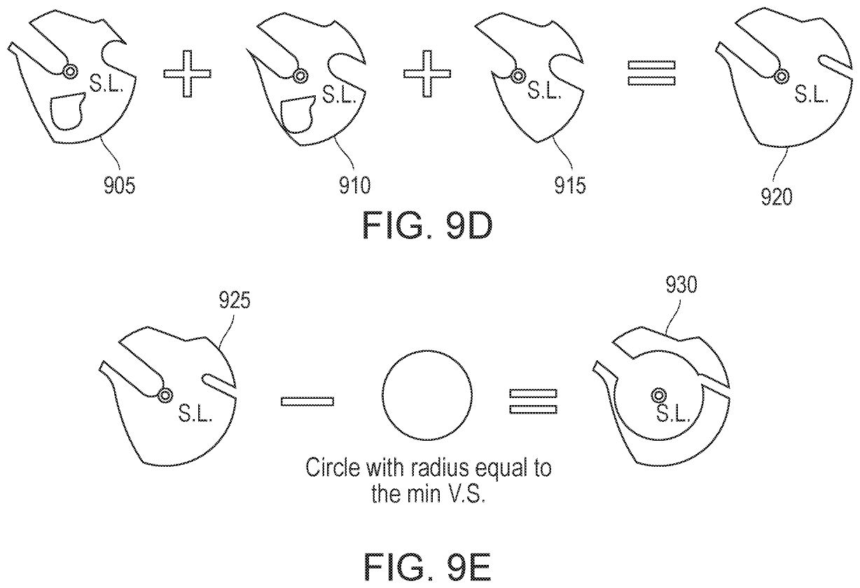

FIGS. 9A-9E illustrate how the final unified polygon of allowable well zones are generated by filtering out the hazard areas, depths restrictions coming from UNGL, LNGL and offset depth as noted above. More particularly. FIG. 9A illustrates a polygon 905 generated for a first offset O1, FIG. 9B illustrates a polygon 910 generated for a second offset O2, and FIG. 9C illustrates a polygon 915 generated for a third offset O3. FIG. 9D illustrates a union of all of the polygons 905, 910, 915, creating a unified polygon 920. After this unification, a circle of radius equal to the minimum V.S. is subtracted to reach finalized polygon 930 for the TE search, shown in FIG. 9E.

The process outlined above essentially projects a 3D problem to 2D with the initial goal of selecting coordinates (X,Y) for the TE in the final polygon derived for the TE environment. The 3D geological model is adequately layered to avoid combining different reservoir facies that cannot be targeted with a single horizontal well owing to drilling limitations. The final polygon 930 illustrated in FIG. 9E demarcates all areas that are suitable for planning considering the reservoir structure, range of offsets (1, 2, . . . , n) from the top of the reservoir, LNGL, UNGL and all hazards considered for planning the well. Once the X, Y coordinates for TE are determined, the depth (Z) value is then determined. If at the end of the process no areas are found suitable, then it is determined that the combination of parameters is correspondingly not suitable.

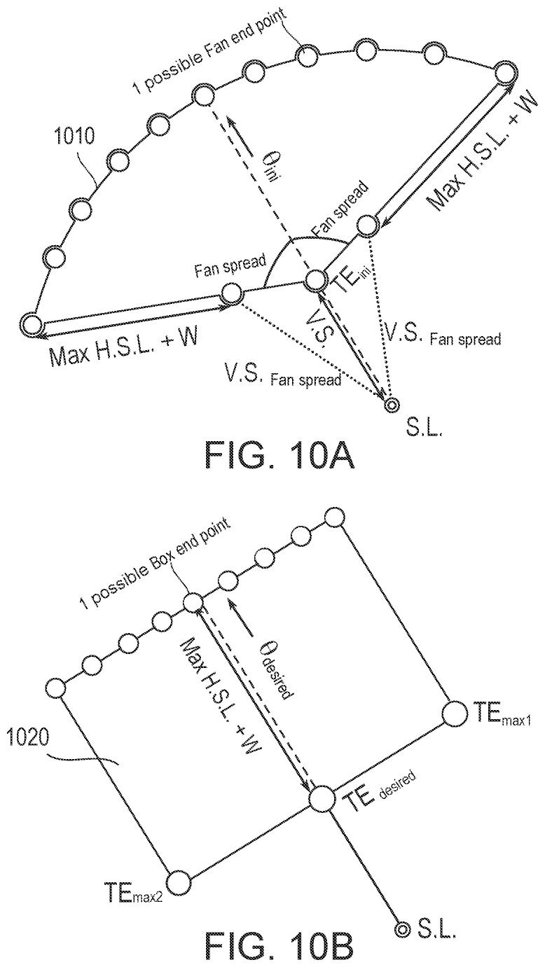

As per the discussion above, for any TE that is qualified, an environment is designed for the Horizontal Section (HS) of the well, within which a well plan is evaluated. In this process, the data used include the parameters of UNGL_{TE}, LNGL_{TE}, UNGL_{TD}, LNGL_{TD}, hazards, offset from structure top, maximum horizontal section length (Max. H.S.L.) and W (a well spacing factor which is greater of the drainage area wells spacing and the maximum anti-collision separation well spacing). For selecting the TD, there are two possible actions: 1) change the azimuth of the well and make small adjustment to the TE; and 2) change the TE and follow the desired Azimuth θ_{desired}. The horizontal section (HS) environment will be created considering these possible actions. For any turn a in the azimuth between SL−TEᵢₙᵢ and TE_{desired}−TD, the V.S. is required to be updated by some function. This function is determined based on drilling parameters. The TEᵢₙᵢ and αₘₐₓ, the maximum allowed turn, provide the set of all possible TEs and TDs, corresponding to an envelope around the TEᵢₙᵢ that has qualified for the evaluation. This envelope is shown in FIG. 10A. This envelope 1010 is referred to as an “HS Fan”. The length between each possible TE and corresponding Fan end point is equal to (Max. H.S.L.+W). If the planner targets a horizontal section along some desired azimuth θ_{desired}, the desired azimuth is taken into account when generating HS Fan. θ_{desired} can be provided by the planner by specifying a value or by using a software program to evaluate the θ_{desired} based on aspects of the reservoir structure. There might be instances in which the |θ_{desired}−θᵢₙᵢ|>αₘₐₓ. In such instances, the HS fan does not include the desired solution. To avoid this circumstance, the HS fan is expanded to whichever is the larger angle of (|θ_{desired}−θᵢₙᵢ|, αₘₐₓ). Based on this we can define Fan Spread as Greater of (|θ_{desired}−θᵢₙᵢ|, αₘₐₓ) shown in FIG. 10A.

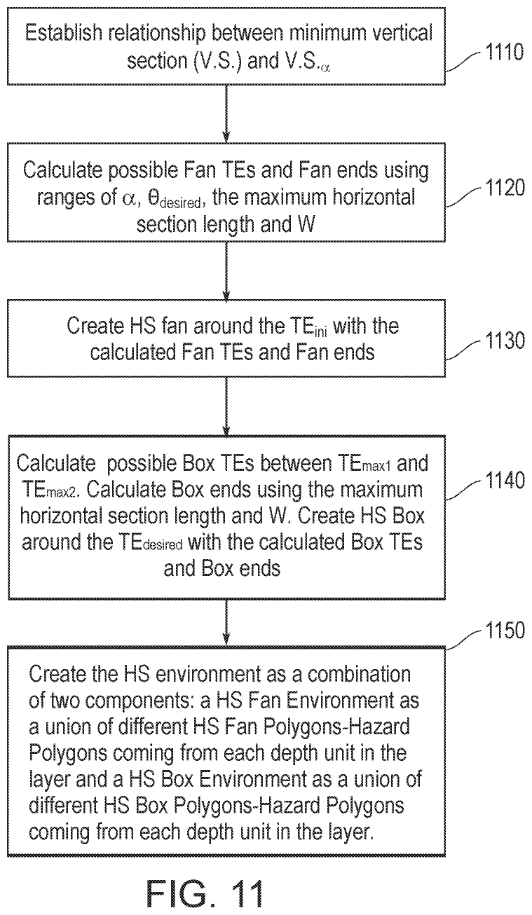

If the initial azimuth determined by θ_{desired} is used, a Box shaped envelope “HS Box” can be created using the maximum V.S. on either side of the TE_{desired}. A rectangular envelop is taken here for simplicity and based on the relationship for V.S._{α} and α, the exact shape may vary. This envelope 1020 is shown in FIG. 10B. The dimensions of the envelope 1020 are (Max. H.S.L.+W)×Distance (TEₘₐₓ₁, TEₘₐₓ₂). TEₘₐₓ₁ and TEₘₐₓ₂ are coordinates located on the Max V.S. circle boundary and are the farthest limits for the possible shift in TE. The length between each possible TE and corresponding Box end point is equal to (Max. H.S.L.+W). FIG. 11 is a workflow of an exemplary method for creating a HS environment. In a first step 1110, the relationship between a minimum vertical section (V.S.) and V.S._{α} (for the difference (α) between the azimuth from SL−TEᵢₙᵢ and the azimuth from TE_{desired}−TD) is established. In step 1120, the possible Fan TEs and Fan ends using ranges of a, θ_{desired}, the maximum horizontal section length and W are calculated. In step 1130, a HS fan is created around the TEᵢₙᵢ using the set of possible Fan TEs and Fan ends. In the following step 1140, the HS Box envelope 1020 is generated. In the final step 1150 the HS environment consisting of two components, a HS Fan environment and HS Box environment is determined as:

$$HS Fan Environment = {{\sum }_{- ( d = 1 )}^{n} [ ( Depth filter ( HS Fan ) - Hazard Polygons ) ]}_{d} HS Box Environment = {{\sum }_{- ( d = 1 )}^{n} [ ( Depth filter ( HS Box ) - Hazard Polygons ) ]}_{d} \qquad ( 1 )$$

If there is a range of offset depths, then the depth ranges are evaluated within the HS Environment for a range of offset depths (d=1 to n) to arrive at a determination. In case of different no-go limits (NGLs) at TE and TD, we can consider a surface of NGLs which can be referred to as an Upper No Go Limit_{TETD} and Lower No Go Limit_{TETD}. Similarly, if there are different offset depths at TE and TD the offset depth can be considered as a surface, Offset Depth_{TETD}. A depth filter is applied and if the deepest depth within the HS Environment>(Upper No go Limit_{TETD}−Offset depth_{TETD}) or the shallowest depth within the HS Environment<(Lower No go Limit_{TETD}−Offset depth_{TETD}) then planning a well with this TE candidate is not suitable. Mathematically, as these are no longer scaler values, matrix forms can be used to perform the relevant calculations. However, if neither of these conditions applies, the environment is generated. Generation of the HS environment follows a similar procedure described above in which 3D Geological model is sliced, environment layers are generated and then unified, creating the final environment. For homogeneous layer-cake reservoirs, this process aids in planning the well at a single offset depth or a range of offset depths as determined by the Offset Depth at TE and Offset Depth at TD in the layer. However, for non-homogeneous reservoirs that exhibit pinch-outs, it may be necessary to navigate between offset depths in the layer that satisfies the reservoir properties and criteria for planning. In this process, some non-reservoir facies may be encountered subject to drilling parameters limitations.

### Selecting the TE

After defining the TE environment, a particular TEᵢₙᵢ is selected. Any selected orientation will correspond to a set of TEᵢₙᵢ points available for evaluation. All candidate points are considered for analysis in a single batch and provided to the Well design Algorithm for evaluation. Once a successful well is determined its parameters are returned as the solution well. To constrain selection based on existing hazards, TEᵢₙᵢ selection starts at a boundary edge of the hazard lying inside the TE Environment. There can be multiple hazards giving these boundary edges for the TEᵢₙᵢ candidates and a suitable convention can be followed to select the first TEᵢₙᵢ.

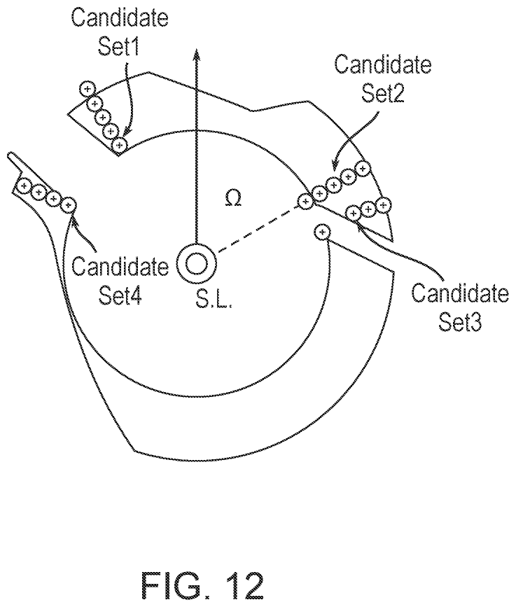

FIG. 12 is a schematic illustration of a selection of TEᵢₙᵢ candidates within the allowed environment according to an embodiment of the present disclosure. As shown, the Azimuth (Ω) from SL−TEᵢₙᵢ at the first step is recorded and the algorithm runs for a full cycle until the next selected TEᵢₙᵢ passes the azimuth value Ω. For the TE candidates, a desired azimuth θ_{desired} is input. If the operator does not provide any θ_{desired} the value θᵢₙᵢ is used as a proxy for θ_{desired}, with θᵢₙᵢ being the azimuth for the current TEᵢₙᵢ as measured from the SL. If the θ_{desired} is different from θᵢₙᵢ, then the vertical section (V.S.) is updated and TE_{desired} is calculated. If |θ_{desired}−θᵢₙᵢ|>αₘₐₓ (the maximum allowed turn), the following conditions apply: after making the TE adjustment for the difference between θ_{desired} and θᵢₙᵢ, the difference between the Azimuth of SL−TE_{desired} (θ_{adjusted}) and θ_{desired} is evaluated. This parameter is referred to as €. For the given value of αₘₐₓ, €ₘₐₓ is determined. If α>αₘₐₓ which implies €>€ₘₐₓ, then the TE_{desired} is adjusted again in the direction of θ_{desired}. A new vertical section is then calculated as:

$$V . S . req = \frac{V . {S}_{α} * sin ( ϵ )}{sin ( {ϵ}_{max} )} \qquad ( 2 )$$

If V.S._{req}>Max V.S., then θ_{desired}=θᵢₙᵢ+/−αₘₐₓ for fork-type and peripheral Injection platforms and θ_{desired}=θᵢₙᵢ for star-shaped arrangements, otherwise the TE is adjusted for θ_{desired}. The value θᵢₙᵢ+/−αₘₐₓ has two possible solutions depending upon the choice of +/− and the result closer to the old θ_{desired} must be chosen. The Final θ_{adjusted} for the new TE is given by θ_{desired}−€ₘₐₓ. Having the direction and distance for the Final TE_{desired} helps in determining the coordinates. All TE_{desired} have an associated TEᵢₙᵢ, that is then used to generate the HS Environment.

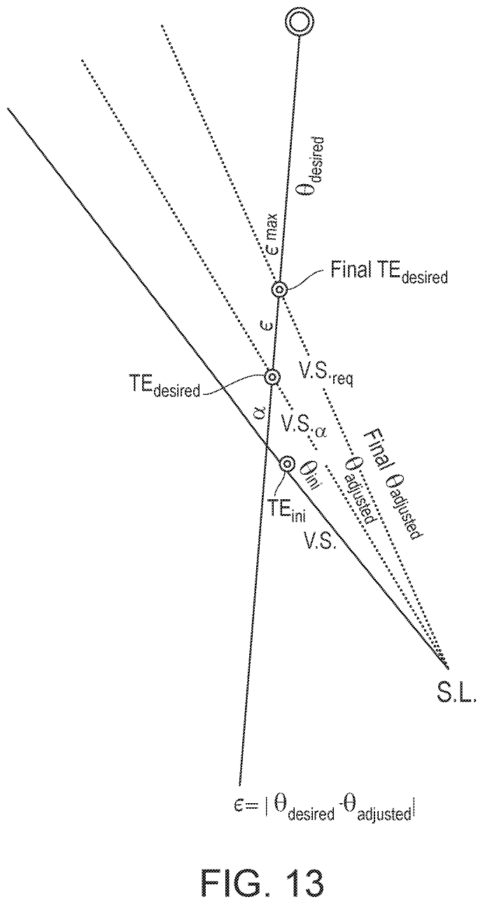

The changes in vertical section corresponding to a TE_{desired} for the case α>αₘₐₓ are illustrated in FIG. 13. Once TE_{desired} is selected it is passed to the well design algorithm (along with the TEᵢₙᵢ) to evaluate whether a well can be planned from this location. If a well can be successfully planned, then the process selects the next TEᵢₙᵢ set after updating the TE environment with the drainage area and anti-collision parameters of the newly created well. If the well-design algorithm does not return a successful well, another TEᵢₙᵢ set is selected near to the previous TEᵢₙᵢ based on a user-defined increment.

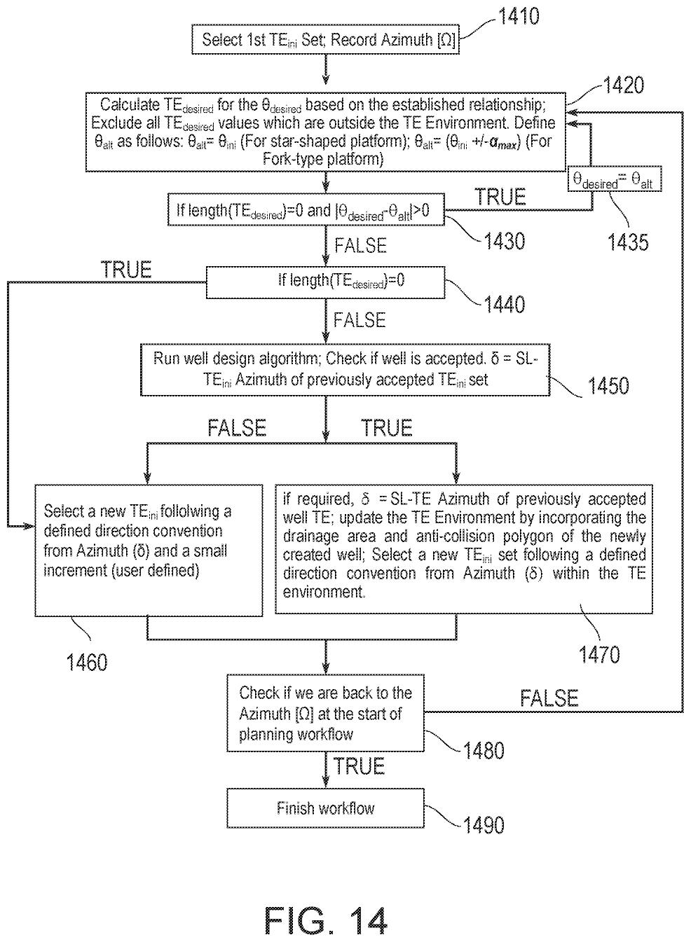

An embodiment of a planning workflow for a star-shaped and fork-type horizontal well platform is now described with respect to the flow chart shown in FIG. 14. In step 1410, a first TEᵢₙᵢ candidate set is selected and an azimuth (Ω) is recorded. In step 1420, the TE_{desired} set is calculated for the θ_{desired} based on the established relationship and all TE_{desired} values which are outside the TE environment are excluded. In the same step 1420, a parameter called θₐₗₜ is defined whose value is as follows:

$${θ}_{alt} = {θ}_{i n i} ( for star - shaped platform ) ;$$

$${θ}_{alt} = ( {θ}_{ini} + / - {α}_{max} ) ( for fork - shaped platform )$$

In a following step 1430 it is determined whether the number of elements in the TE_{desired} set, represented by the length of (TE_{desired}) is equal to zero and |θ_{desired}−θₐₗₜ|>0. If this is the case (true), θ_{desired} is set equal to θₐₗₜ in step 1435. If the determination in step 1430 is false, then the flow proceeds to step 1440 in which there is another determination as to whether the length of TE_{desired}=0. If the determination in step 1440 proves false, then in step 1450 the well design algorithm is executed and well acceptance is checked. If the determination in step 1440 proves true, then the flow shifts to step 1460 in which a new TEᵢₙᵢ set is selected within the TE environment based on an increment from the previously accepted azimuth δ=Azimuth from SL−TEᵢₙᵢ of previously accepted TEᵢₙᵢ, following a defined direction convention from the azimuth δ. Similarly, step 1460 is reached from step 1450 if the well design algorithm does not accept the well. If, in step 1450, the well is accepted, then in step 1470 the TE environment is updated by incorporating the drainage area and anti-collision polygon of the newly created well. If the direction of the TE of the accepted well from the TEᵢₙᵢ is same as our defined direction convention for movement, δ can be updated to Azimuth from SL−TE of the accepted well. This update to δ may vary from case to case. A new TEᵢₙᵢ set is selected within the TE environment, following a defined direction convention from the azimuth δ. The flow after execution of either step 1460, 1470 proceeds to step 1480 in which it is determined whether the process has returned to the original azimuth (Ω) at the start of the planning workflow. If the determination in step 1480 proves true, then the process ends in step 1490. If the determination is step 1480 proves false, the process cycles back to step 1420.

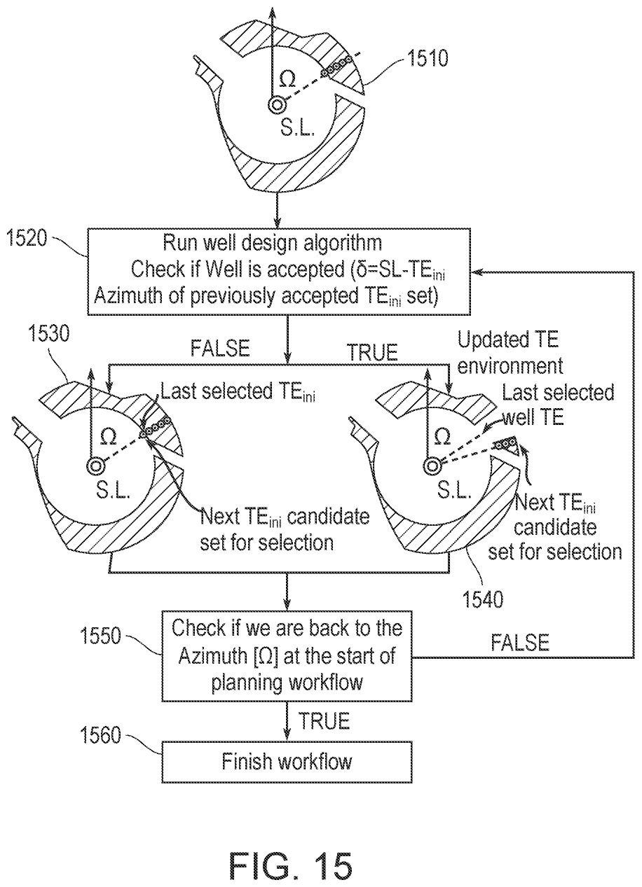

FIG. 15 is a schematic illustration of a work flow for the star-shaped/fork-type platform pattern. In step 1510 (shown pictorially), a candidate TE_{desired} is selected (taken in some predefined orientation, such as clockwise) after adjustment for θ_{desired}. In the following step 1520, the well design algorithm is executed, and it is determined whether the well based on the selected TE_{desired} is accepted. If the determination in step 1520 proves false, in step 1530 a new TEᵢₙᵢ is selected based on an incremental change from the previous TEᵢₙᵢ. If the determination in step 1520 proves true, the process flows to step 1540, in which the TE environment is updated from the newly accepted well, and a new TEᵢₙᵢ candidate is set for a further well. From either step 1530 or 1540, the flow proceeds to step 1550, in which it is determined whether the selection procedure has returned to the original azimuth (Ω) at the start of the planning workflow. If the determination in step 1550 is true, then the process ends in step 1560. If, contrarily, the determination in step 1550 is false, the process cycles back to step 1520 after calculating the TE_{desired}.

In current implementations, for star shaped and fork-type platform patterns, the subsequent TE can be selected after the TE of a previously accepted well, with an increment along the TE Environment. For peripheral injection wells, a subsequent TE can be selected after the TD of a previously accepted well with an increment along the TE Environment and the workflow is split between two directions.

With regard to peripheral injection well planning, there are typically two distinct types: water injection and gas injection. Peripheral water injection generally has either an upper no-go limit or an oil-water contact surface to define the environment, while peripheral gas injection has either a lower no-go limit or a gas-oil contact surface to define environment limits. In either case, the injector wells are lined up along the limits defined by the structure. In contrast to the star-shaped and fork-type designs, in peripheral injection designs a full circular scouting around the environment is not required; the TEᵢₙᵢ is selected after the TD for the selected well. Planning can be split between two directions and the workflow for each direction ends when the selected TEᵢₙᵢ falls outside the outermost periphery of the TE environment.

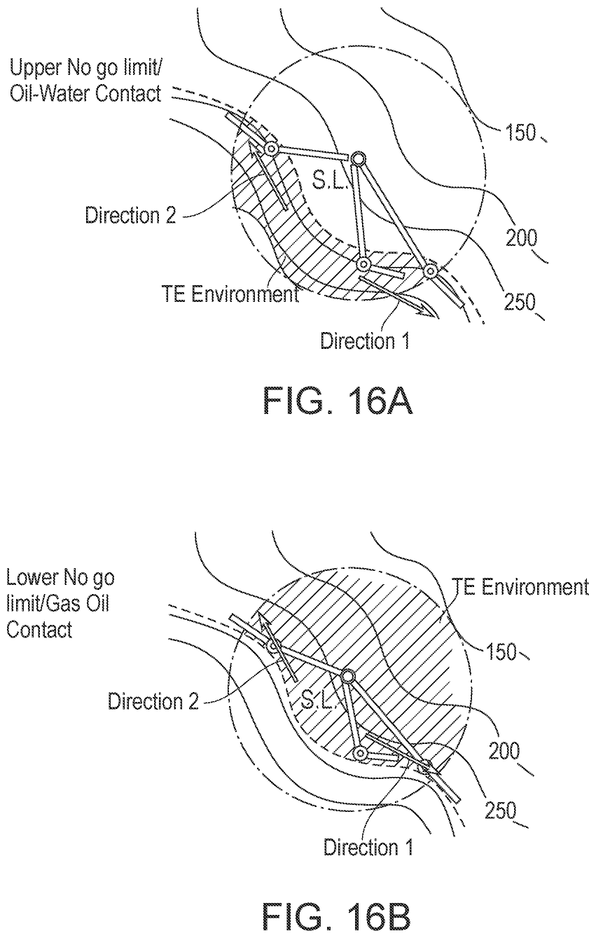

A user can select points on the structure and the corresponding X, Y coordinates can be determined by the well planning application on a computing device. The user can be prompted to select the starting point. An initial set of TEᵢₙᵢ values (falling within the TE environment) and azimuth (Ω) are then recorded. The initial TEᵢₙᵢ set is adjusted to calculate TE_{desired}, and the θ_{desired} is calculated from the structure. The value of θ_{desired} is particularly important for planning of peripheral injection wells. The TE is passed to the well design algorithm to evaluate for planning the well along θ_{desired}. If a well is accepted then the TD is determined. After determination of the TD the next TEᵢₙᵢ set is selected. If the new TEᵢₙᵢ is completely outside the outer boundaries of the TE environment, then the workflow should switch to next direction. The user can be prompted to select the starting point of the next direction. FIG. 16A shows an example of a TE environment for a peripheral water injection well. As shown, the TE environment is bound by either an oil/water contact surface or an upper no-go limit. FIG. 16A depicts two possible peripheral well directions that can be selected based on distinct starting TE locations. FIG. 16B shows an example of a TE environment for a peripheral gas injection well. A gas/oil contact surface determines a lower no-go limit for the TE environment in this case. FIG. 16B depicts two possible peripheral well orientations that can be selected based on distinct starting TE locations.

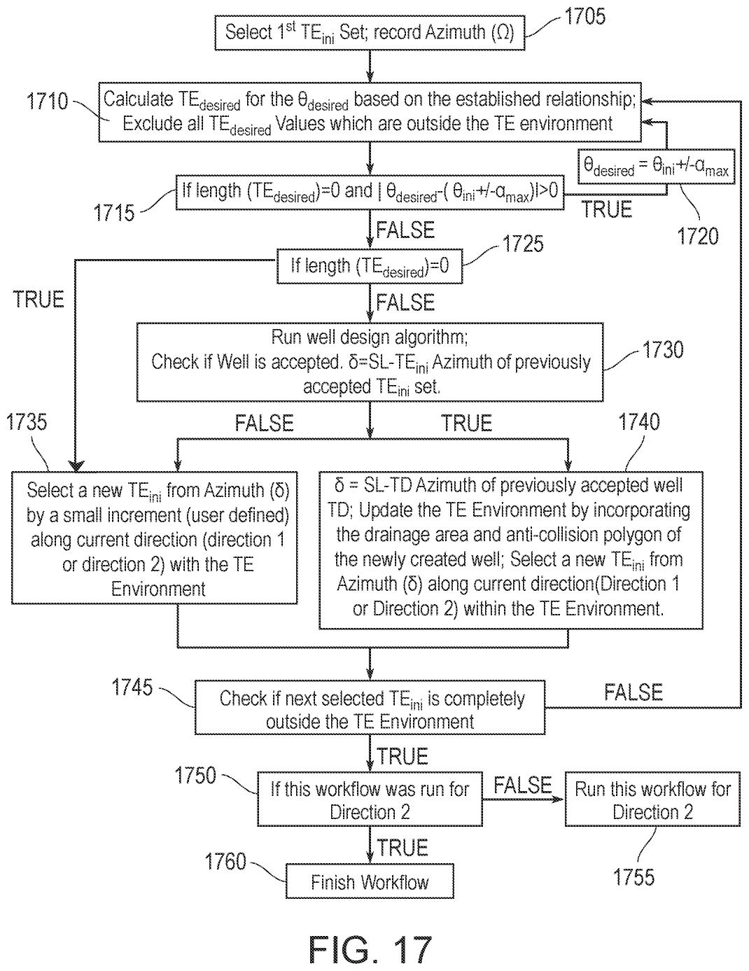

FIG. 17 is a flow chart of an embodiment of a method for peripheral injection planning. In step 1705, the first set of TEᵢₙᵢ candidates is selected and an azimuth (Ω) is recorded. In step 1710, TE_{desired} is calculated for the θ_{desired} and all TE_{desired} values that are outside of the TE environment are excluded. In a following step 1715, it is determined if the length of TE_{desired} is equal to zero and the absolute value of the difference between θ_{desired} and (θᵢₙᵢ+/−αₘₐₓ) is greater than zero. If in step 1715 the determination is true, then in step 1720 θ_{desired} is updated to (θᵢₙᵢ+/−αₘₐₓ) and the process cycles back to step 1710. The choice of +/− should be done in the same manner as for fork-type arrangement. If, on the contrary, the determination in step 1715 is false, then in step 1725 it is further determined whether the length of TE_{desired} is equal to zero (sole condition). If the length of TE_{desired} is determined not equal to zero (false), then the process flow proceeds to step 1730 in which the well design algorithm is executed and it is determined whether the well is accepted. The azimuth of the previously accepted TEᵢₙᵢ set is δ=Azimuth from SL−TEᵢₙᵢ. If either the well is not accepted in step 1730, or the length of TE is equal to zero (step 1725), then in step 1735 a new TEᵢₙᵢ set is selected within the TE environment based on an increment from the previously accepted azimuth δ, along the direction currently being executed. If the well is accepted in step 1730, in step 1740 the TE environment is updated by incorporating the drainage area and anti-collision polygon of the newly created well. The azimuth δ is updated as δ=Azimuth from SL−TD of accepted well. Another TEᵢₙᵢ set is selected within the TE environment based on an increment from the previously updated azimuth δ, along the direction currently being executed. After either step 1735 or step 1740, in step 1745 it is determined whether the newly selected TEᵢₙᵢ is within or completely outside of the TE environment. Completely outside the TE environment implies that the TE candidate set is outside the outermost periphery of the TE environment. If the TEᵢₙᵢ is not completely outside the TE environment, the process cycles back to step 1710. If the TEᵢₙᵢ is completely outside the TE environment, it is determined, in step 1750, whether the process was executed for Direction 2. If not, in the following step 1755 the entire process is re-executed for Direction 2. Otherwise, in step 1760, the process ends.

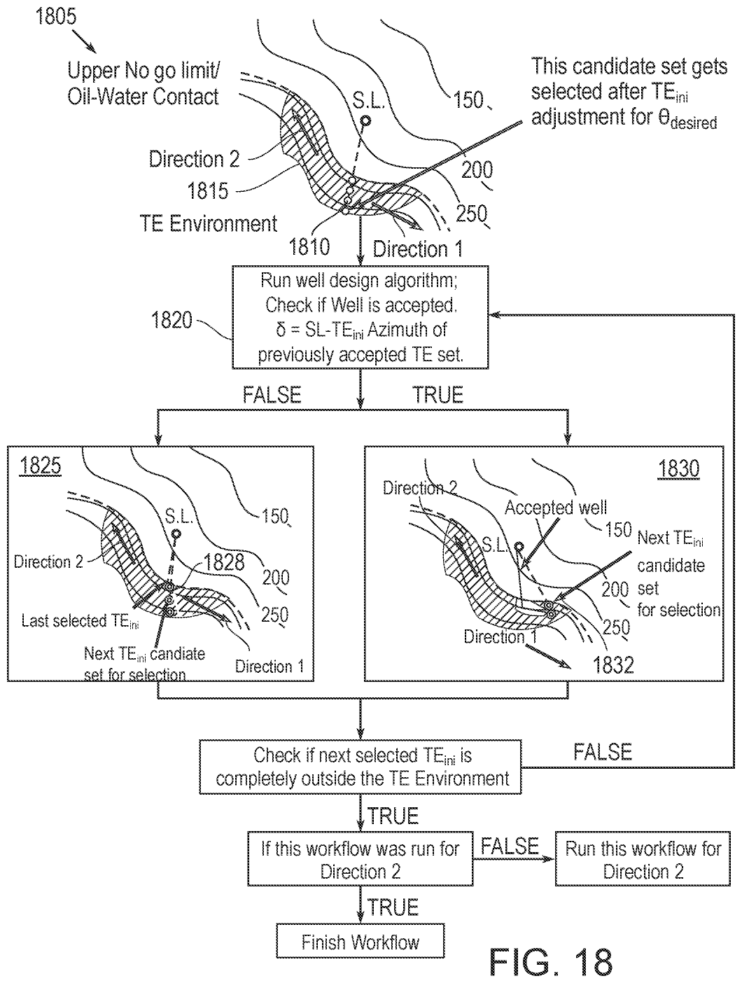

FIG. 18 is a pictorial illustration of the peripheral injection planning process described above with respect to FIG. 17. First step 1805 shows selection of a candidate TE_{desired} set 1810 in a TE environment 1815. The two directions for the peripheral injection are also shown. The following step 1820 is equivalent to step 1730 of FIG. 17, in which the well design algorithm is executed and it is determined whether the well is accepted. If the well is not accepted in step 1820, in step 1825 a new TEᵢₙᵢ set 1828 is selected based on an increment from the previously accepted azimuth δ. If the well is accepted in step 1820, the next TEᵢₙᵢ set 1832 is selected in Direction 1 from the last TD of the well accepted in step 1820. Proceeding from either step 1825 or step 1830, in step 1835 it is determined whether the selected TEᵢₙᵢ is completely outside the TE environment. If it is determined that the selected TEᵢₙᵢ is not completely outside the TE environment in step 1835, the process cycles back to step 1820 after making the TE_{desired} calculations. Otherwise, if it is determined that the selected TEᵢₙᵢ is completely outside the outer periphery of the TE environment, then the process follows the same steps as 1750, 1755 and 1760 of FIG. 17 in corresponding steps 1840, 1845 and 1850 of FIG. 18.

### Well Design Process

The well design process is intended to evaluate multiple well scenarios with respect to the environment given a TE_{desired} set, and to output a “reward” for each evaluation. An initial step is evaluating whether a well can be designed with the TE_{desired} and minimum horizontal section length parameters along the θ_{desired}. All TEs are adjusted for any difference in the θ_{desired} and θᵢₙᵢ before being evaluated in well design process. In some implementations, θ_{desired} is also adjusted when it does not return a TE_{desired} set. In this process, an optimal solution is posited based on these input parameters. If it is not possible to plan a well with these input parameters, the TE and TD is adjusted based on a deterministic policy. The solution that requires minimal shift in the target coordinates is ultimately selected.

An optimal solution well is parameterized by TE_{desired}, TD_{desired}, θ_{desired} and TEᵢₙᵢ. The first well to be evaluated is attributed with these parameters. If it is determined that these parameters are not suitable for a well, a reinforcement learning algorithm is executed to determine an alternative optimal solution for a given TE. As noted above, the elements of a reinforcement learning algorithm includes actions, states, policies and rewards. The actions are modifications made by an agent within the environment. In particular, according to the present disclosure the actions include shifting the TE and TD. A state is a set of conditions returned by the environment after each action. The state can include the current position of the wellbore between TE−TD with respect to the horizontal section environment. In preferred implementations, each state is parameterized by TEₛ, TDₛ and θₛ. A state space is defined as the entire region of all possible states. A policy is a strategy applied by the agent for the next action based on the current state. In the current context, policies can include: 1) changing the horizontal section azimuth and also the TE; and 2) changing the TE while keeping the horizontal section azimuth constant. In this case, there is dual-policy reinforcement learning whereby policies 1) and 2) compete to provide a solution. The reward is a parameter returned by the environment to the agent to evaluate the action.

If there is no initial information for the agent about the environment, there can be an infinite number of possible arrangements of the existing hazards, therefore, the agent explores all possible states. The state that returns the maximum reward is selected as the solution. For the sake of simplicity, only a single lateral well case is described, but similar principles apply for multi-lateral wells. The reward is defined based on the problem and in the present context the reward is defined as a vector by the following function:

$$R = [ \begin{matrix}{Reward}_{magnitude} & {Reward}_{direction}\end{matrix} ] = [ \begin{matrix}β \times \frac{1}{( \vert {TE}_{d esired} - T {E}_{S} \vert )} \times \frac{1}{( \vert {TD}_{d esired} - T {D}_{S} \vert )} \times N & C\end{matrix} ] \qquad ( 3 )$$

In function (3), β is a logical flag that indicates whether a state leads to the well exiting the environment, with the goal being to plan the well is to stay inside the TE and HS environments. This parameter can be found by evaluating the intersection between the well path in the current state and the TE and HS environments. β=1 for the state when the TE and HS are inside their respective environments; β=0 otherwise. |TE_{desired}−TEₛ| is the absolute value of the difference between the desired TE (TE_{desired}) and the current state TE (TEₛ). TEₛ ranges between TEᵢₙᵢ to TEₘₐₓ on either side. |TD_{desired}−TDₛ| is the absolute value of the difference between the desired TD (TD_{desired}) and the current state TD (TDₛ). N is a normalization factor considering that the parameters |TE_{desired}−TEₛ|, |TD_{desired}−TDₛ| usually range in 10s-100s of units. The N factor ensures that the rewards are not minute with respect to the computational precision. C is a convention factor that records the direction of the state with respect to the desired state. It aids in prioritizing one out of two states in case states arising from two different directions return equal rewards. The rewards are evaluated in absolute values coming from Reward_{magnitude} and the C term is used in Reward_{direction} to eliminate two states with equal rewards coming from opposite directions with respect to the desired state.

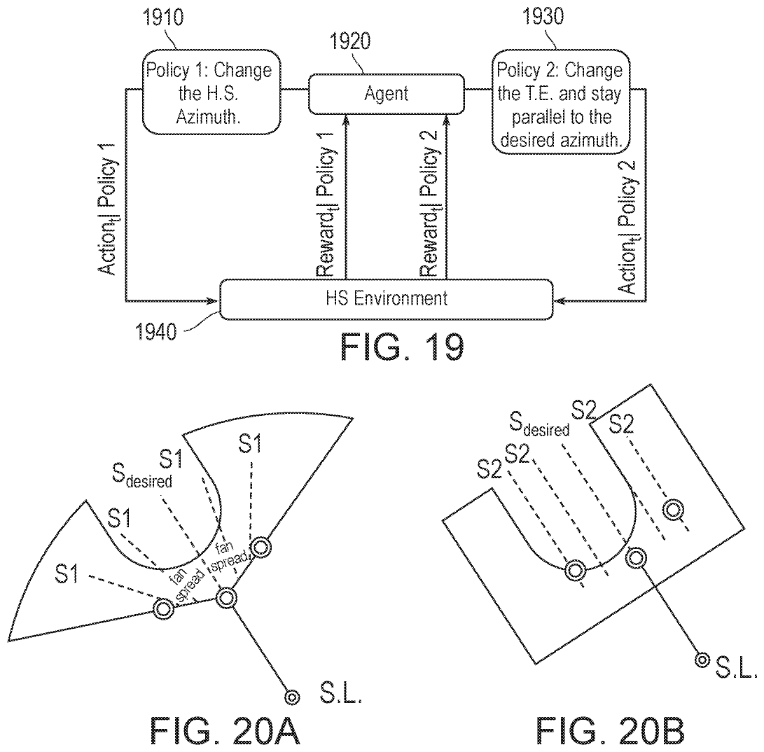

FIG. 19 is a schematic flow diagram of a dual policy reinforcement learning schema according to the present disclosure. In this schema, a dual policy approach is employed, and R values are calculated for each policy across the state space. In FIG. 19, a first policy 1910 (Policy 1) directs an agent 1920 to change the horizontal section azimuth. A second policy 1930 (Policy 2) directs the agent 1920 to change the TE and stay parallel to the desired azimuth. These policies govern the interaction of the agent with the HS environment 1940. In turn, the HS environment delivers a reward based on the first policy 1910 to the agent 1920 and a reward based on the second policy 1930 to the agent. If no successful evaluation is possible after evaluating the entire state space based on the policies, Reward_{magnitude} will be zero for all states indicating no solution is possible. Then the flow proceeds to the next TE. A matrix containing the individual state parameters can be created and used to evaluate the results to save computational time. FIG. 20A is a schematic illustration of a number of states (each labeled S1) evaluated under the first policy and FIG. 20B is a schematic illustration of states (each labeled S2) evaluated under the second policy.

The Reward_{magnitude} can yield same results based on two policies. For example, for a particular scenario |TE_{desired}−TEₛ|=2 and |TD_{desired}−TDₛ|=2, the resultant factor

$$\frac{1}{( \vert {TE}_{desired} - {TE}_{S} \vert )} \times \frac{1}{( \vert {TE}_{desired} - {TE}_{S} \vert )} = 1 / 4 ;$$

in another scenario |TE_{desired}−TEₛ|=1 and |TD_{desired}−TDₛ|=4, the resultant factor

$$\frac{1}{( \vert {TE}_{desired} - {TE}_{S} \vert )} \times \frac{1}{( \vert {TE}_{desired} - {TE}_{S} \vert )} = 1 / 4 .$$

However, these scenarios can be differentiated by the factor

$$\frac{1}{( \vert {θ}_{desired} - {θ}_{s} \vert + 1 )} .$$

Therefore, for the states where

$${( \frac{1}{( \vert {TE}_{desired} - {TE}_{S} \vert )} \times \frac{1}{( \vert {TE}_{desired} - {TE}_{S} \vert )} )}_{Policy 1} = {( \frac{1}{( \vert {TE}_{desired} - {TE}_{S} \vert )} \times \frac{1}{( \vert {TE}_{desired} - {TE}_{S} \vert )} )}_{Policy 2}$$

the reward magnitude equation can be updated to

$${Reward}_{magnitude} = β \times \frac{1}{( \vert {θ}_{desired} - {θ}_{s} \vert + 1 )} \times \frac{1}{( \vert {TE}_{desired} - {TE}_{S} \vert )} \times \frac{1}{( \vert {TE}_{desired} - {TE}_{S} \vert )} \times N .$$

θ_{desired} and θᵢₙᵢ may be same or different. A factor of 1 is added to the denominator which makes all situations in which |θ_{desired}−θₛ|=0, the denominator will have a value of 1. Any deviation from θ_{desired} will make the entire term less than 1, decreasing the reward. This reward magnitude equation is also preferable if it is desired to prioritize the states with an azimuth close to θ_{desired} as in fork-type and peripheral Injection platforms.

Embodiments of the reinforcement learning method are designed to determine the maximum number of possible (TE. TD) pairs that can be generated based upon the provided input parameters. Like the above method of assigning rewards based on the state space, rewards can be provided to all the accepted states (wells) based upon reasonable criteria and prioritize a selection in case some wells are of more interest than others. Furthermore, multi-lateral algorithms can be designed by evaluating how single lateral wells can be joined to satisfy the well design.

After the TE and TD have been determined, Z values can be calculated. As required, specific control points can be added between TE and TD to plan the well within the reservoir unit structurally and/or stratigraphically. To calculate the Z-value, an offset depth having a favorable environment for the TE, TD and the control points is selected. As the TE, TD is derived by performing a joint operation on the environments generated at different depths, there might be several possible Z values and an appropriate Z value (user preferred) can be selected as the final Z value. After calculating the Z-values for TE, TD and control points, a suitable well path can be generated from SL−TE−TD, and anti-collision assessment for the new well from SL−TD can be performed along with Dogleg severity and Reservoir contact assessments to successfully select a well. Since the environment has accounted for the anti-collision between TE−TD, in the final step anti-collision of well path from SL−TE is evaluated.

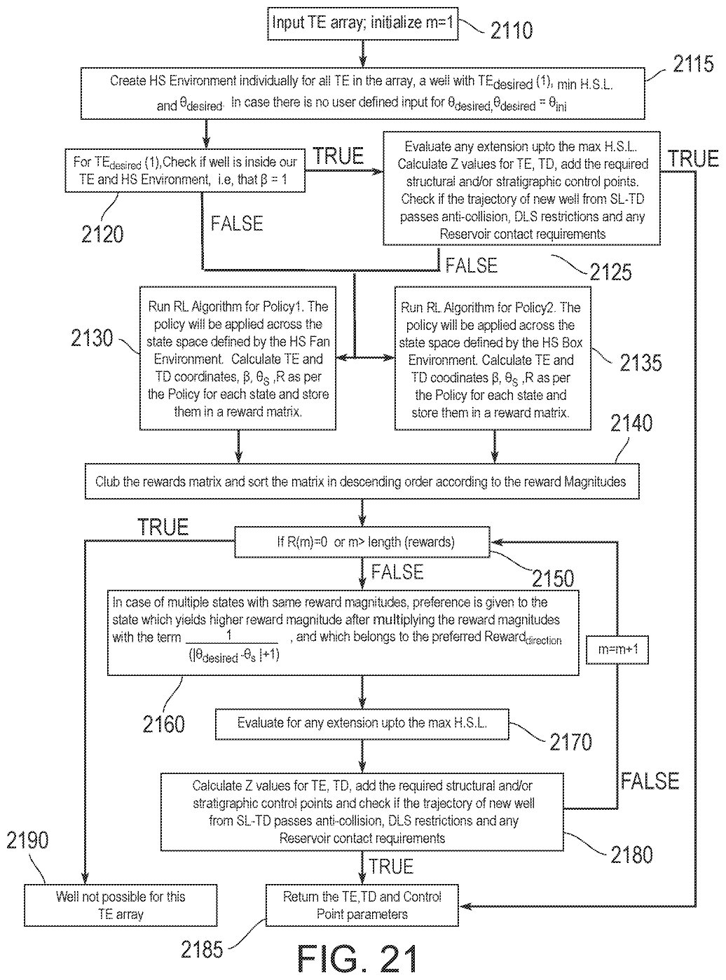

Turning now to FIG. 21, which is a flow chart of a comprehensive well design method according to the present disclosure, in a first step 2110 TE array (including TEᵢₙᵢ and TE_{desired}) is provided as input and the number of iterations is initialized to m=1. In a following step 2115, the horizontal section environment is created for all TEᵢₙᵢ in the TEᵢₙᵢ array and a well with TE_{desired} (1), minimum H.S.L. and θ_{desired} is created. In some instances, there can be no user-defined input for θ_{desired}, in which case, θ_{desired}=θᵢₙᵢ. In step 2120, it is determined whether the candidate well is inside the TE and HS Environment, i.e., that β=1. If the determination in step 2120 proves true, then in step 2125 well is evaluated for any extension upto the max H.S.L, Z values for TE, TD are calculated, the required structural and/or stratigraphic Control Points are added and the trajectory of new well from SL−TD is checked to evaluate if it passes anti-collision, Dogleg Severity (DLS) restrictions and any Reservoir contact requirements. If the trajectory of the new well passes the anti-collision, DLS restrictions and reservoir contact requirements, the process skips to step 2185 in which the method outputs TE, TD and Control Point parameters for a valid candidate well that can be planned between the coordinates of TE and TD. If, in step 2125, the trajectory of the new well does not pass these requirements, the method proceeds to parallel steps 2130, 2135. Similarly, if the determination in step 2120 proves false, then two parallel steps 2130, 2135 are executed cither simultaneously or sequentially. In step 2130, the reinforcement learning algorithm is executed under policy 1 which is applied across the state space defined by the HS Fan environment. The TE and TD coordinates, β, θ_{S}, and R are calculated for each state according to the policy 1. In step 2135, the reinforcement learning algorithm is executed under policy 2 which is applied across the state space defined by the HS Box environment. The TE and TD coordinates, β, θ_{S}, and R are calculated for each state according to the policy 2.

Following step 2130 and 2135, all the TE and TD coordinates, β, θ_{S}, and R calculated under policy 1 and policy 2 are clubbed together in a single matrix, called rewards for instance, and sorted in descending order of the reward magnitudes in step 2140. This step brings the highest reward state and its R value at the top of the matrix. In step 2150 it is determined if the highest reward under current iteration m is zero or the iteration is greater than the length of rewards matrix, where the length of rewards matrix is equal to the total number of states under Policy 1 and Policy 2. The term m greater than length of rewards matrix implies that all states have been evaluated. If the determination in step 2150 proves true, the process decides that there is no Well possible for this TE array and the workflow ends without accepting any well. If the determination in step 2150 proves false, the process proceeds towards step 2160 where, in the case of multiple states with same reward magnitude, preference is given to the state which yields higher reward magnitude after multiplying the reward magnitudes with the term

$$\frac{1}{( \vert {θ}_{desired} - {θ}_{s} \vert + 1 )} ,$$

and which belongs to the preferred Reward_{direction}. Following step 2160, in step 2170 the well is evaluated for any extension upto the maximum H.S.L. In step 2180, Z values for TE, TD are calculated, the required structural and/or stratigraphic Control Points are added and the trajectory of new well from SL−TD is checked to evaluate if it passes anti-collision, Dogleg Severity (DLS) restrictions and any Reservoir contact requirements. If the determination in step 2180 proves true, the process skips to step 2185 in which the method outputs TE, TD and Control Point parameters for a valid candidate well that can be planned between the coordinates of TE and TD. If the determination in step 2180 proves to be False, the algorithm cycles back to step 2150 with the iteration number updated by 1 (m=m+1).

The reinforcement learning method discussed herein describes embodiments of a machine Learning workflow for automated wellbore planning based on a wide variety of engineering and geological parameters. The TE and HS environments are generated and the computations can be converted from a three-dimensional to a two-dimensional problem. Embodiments of the reinforcement learning method employ two policies independently and evaluate the best solution out of the two policies. The well design method ultimately determines whether a well is possible for a given heel point (TE). All possible movements for a given TE are captured to plan wells in extremely complex environments. All initial and exit points for the method are defined to enable the determination to occur.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components or steps described and illustrated with reference to the figures are required for all embodiments or arrangements.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and “comprising”, when used in this specification, specify the presence of stated features, integers, steps, operations, elements, or components, but do not preclude the presence or addition of one or more other features, integers, steps, operations, elements, components, or groups thereof.

Terms of orientation are used herein merely for purposes of convention and referencing and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A method of using a reinforcement learning algorithm to plan a prospective horizontal well that drains a reservoir characterized by a starting point (heel (TE)) and an end point (toe (TD)) under a preset surface location (SL), the method comprising:
defining a spatial environment in which the horizontal well can be planned that takes into account depth constraints, hazard areas and the existence of pre-existing wells;
executing a reinforcement learning algorithm that takes as input initial target TE and TD locations (TE_{desired}, TD_{desired}), makes an initial determination as to whether a well can be planned in the environment using (TE_{desired}, TD_{desired}) and if a well cannot be planned using TE_{desired}, TD_{desired}, executes actions to change from one of the target locations to several new locations (TE₁, TD₁, TE₂, TD₂ . . . TEₙ, TDₙ), and determines a state and a reward for each of the new locations, wherein one of the several new locations obtains a higher reward from the algorithm and termed a favored location;
determining whether a well can be planned at the favored location based on the environment; and
returning TE, TD and Control Point(s) of the favored location when it is determined that a well can be planned using TE and TD coordinates of the favored location.

2. The method of claim 1, wherein the actions are based on two policies, a first policy in which the starting point of the horizontal section of the well (TE) is changed and the horizontal section azimuth of the well is changed, and a second policy in which the starting point of the horizontal section of the well (TE) is changed while the horizontal section azimuth is not changed.

3. The method of claim 1, wherein defining the spatial environment includes setting three-dimensional upper and lower no-go zone contours which no part of the prospective horizontal well can intersect.

4. The method of claim 1, wherein defining the spatial environment includes setting a minimum vertical section value of the TE with respect to the surface location (SL) and setting maximum vertical section value of the TE with respect to the surface location (SL).

5. The method of claim 1, wherein defining the spatial environment includes a minimum and a maximum horizontal length of the prospective horizontal well.

6. The method of claim 1, prior to returning the TE and TD of the favored location, calculating depth (Z) values of the TE and TD of the favored location.

7. The method of claim 6, further comprising checking if a trajectory of a new well from SL to TE and then from TE to TD passes anti-collision criteria, Dogleg Severity (DLS) restrictions and any Reservoir contact requirements.

8. The method of claim 1, wherein defining the spatial environment further comprises generating a horizontal section environment.

9. The method of claim 8, wherein generating a horizontal section environment includes establishing a relationship between a minimum vertical section (V.S.) and V.S._{α} corresponding to a difference (α) between the azimuth from SL−TEᵢₙᵢ and the azimuth from TE_{desired}−TD.

10. The method of claim 9, further comprising calculating a set of potential TEs and ending locations (Fan ends) using TEᵢₙᵢ, ranges of α, θ_{desired}, Max H.S.L. and W.

11. The method of claim 10, further comprising generating a spatial fan (HS Fan) around the TEᵢₙᵢ location using the set of potential TEs and ending locations (Fan ends).

12. The method of claim 11, further comprising generating a horizontal section Box envelope (HS Box) using the maximum vertical section on either side of the TE_{desired}, Max H.S.L. and W.

13. The method of claim 12, further comprising determining a horizontal fan environment as:
Σ_ⁿ_{(d=1)}[(Depth filter(HS Fan)−Hazard Polygons)]_{d}

14. The method of claim 12, further comprising determining a horizontal box environment as:
Σ_ⁿ_{(d=1)}[(Depth filter(HS Box)−Hazard Polygons)]_{d}

15. A non-transitory computer-readable medium comprising instructions which, when executed by a computing device system, cause the computer system to carry out method of using a reinforcement learning algorithm to plan a horizontal well that drains a reservoir characterized by a starting point (heel (TE)) and an end point (toe (TD)), including steps of:
defining a spatial environment in which the horizontal well can be planned that takes into account depth constraints, hazard areas and the existence of pre-existing wells;
executing a reinforcement learning algorithm that takes as input initial target TE and TD locations (TE_{desired}, TD_{desired}), makes an initial determination as to whether a well can be planned in the environment using (TE_{desired}, TD_{desired}) and if a well cannot be planned using TE_{desired}, TD_{desired}, executes actions to change from one of the target locations to several new locations (TE₁, TD₁, TE₂, TD₂ . . . TEₙ, TDₙ), and determines a state and a reward for each the new locations, wherein one of the several new locations obtains a higher reward from the algorithm and termed a favored location;
determining whether a well can be planned at the favored location based on the environment; and
returning a TE, TD and Control Points of the favored location when it is determined that a well can be planned using TE and TD coordinates of the favored location.

16. The non-transitory computer-readable medium of claim 15, wherein the actions are based on two policies, a first policy in which the starting point of the horizontal section of the well (TE) is changed and the horizontal section azimuth of the well is changed, and a second policy in which the starting point of the horizontal section of the well (TE) is changed while the horizontal section azimuth is not changed.

17. The non-transitory computer-readable medium of claim 15, wherein defining the spatial environment includes setting three-dimensional upper and lower no-go zone contours which no part of the prospective horizontal well can intersect.

18. The non-transitory computer-readable medium of claim 15, wherein defining the spatial environment includes setting a minimum vertical section value of the TE with respect to the surface location (SL) and setting maximum vertical section value of the TE with respect to the surface location (SL).

19. The non-transitory computer-readable medium of claim 15, wherein defining the spatial environment includes a minimum and a maximum horizontal length of the prospective horizontal well.

20. The non-transitory computer-readable medium of claim 15, prior to returning the TE and TD of the favored location, calculating depth (Z) values of the TE and TD of the favored location.

21. The non-transitory computer-readable medium of claim 20, further comprising instructions which, when executed by a computing device system, cause the computer system to check if a trajectory of a new well from SL to TE and then from TE to TD passes anti-collision criteria, Dogleg Severity (DLS) criteria and Reservoir contact requirements criteria.

22. The non-transitory computer-readable medium of claim 15, wherein defining the spatial environment further comprises generating a horizontal section environment.

23. The non-transitory computer-readable medium of claim 22, wherein generating a horizontal section environment includes establishing a relationship between a minimum vertical section (V.S.) and an initial V.S. corresponding to a difference (α) between the azimuth from SL−TEᵢₙᵢ and the azimuth from TE_{desired}−TD.

24. The non-transitory computer-readable medium of claim 23, further comprising instructions which, when executed by a computing device system, cause the computer system to calculate a set of potential TEs and ending locations (Fan ends) using TEᵢₙᵢ, ranges of α, θ_{desired}, Max H.S.L. and W.

25. The non-transitory computer-readable medium of claim 24, further comprising instructions which, when executed by a computing device system, cause the computer system to generate a spatial fan (HS Fan) around the TEᵢₙᵢ location using the set of potential ending locations (Fan ends).

26. The non-transitory computer-readable medium of claim 25, further comprising instructions which, when executed by a computing device system, cause the computer system to generate a horizontal section Box envelope (HS Box) using the maximum vertical section on either side of the TE_{desired}, Max H.S.L. and W.

27. The non-transitory computer-readable medium of claim 26, further comprising instructions which, when executed by a computing device system, cause the computer system to determine a horizontal fan environment as:
Σ_ⁿ_{(d=1)}[(Depth filter(HS Fan)−Hazard Polygons)]_{d}

28. The non-transitory computer-readable medium of claim 26, further comprising instructions which, when executed by a computing device system, cause the computer system to determine a horizontal box environment as:
Σ_ⁿ_{(d=1)}[(Depth filter(HS Box)−Hazard Polygons)]_{d}
